(19) United States
(12) Patent Application Publication
(10) Pub. No.: US 2010/0013661 A1
(43) Pub. Date: Jan. 21, 2010

(54) Method and System for Providing Service to Deaf and Hard-of-Hearing

(75) Inventors: Patrick H. Hughes, JR., Evanston, IL (US); Carey G. Siegel, Chicago, IL (US); Christopher E. Haigh, Chicago, IL (US)

Correspondence Address: IP Advisors;Christopher Haigh, 150 N. Michigan Ave., STE. 2800, CHICAGO, IL, 60601, US

(73) Assignee: INCLUSION SOLUTIONS, LLC, Chicago, IL (US)

(21) Appl. No.: 12/177,076

(22) Filed: Jul. 21, 2008

(51) Int. Cl. G09B 21/00

(52) U.S. Cl. 340/825.19

(57) ABSTRACT

A method and system for taking orders from a person are disclosed. The system and method may include a notification system and station that notifies a service associate of the need for assistance, and an ordering station wherein service is provided to the user in need. A button may be used as a trigger for a user to indicate he needs assistance. An internal notification system may be connected either wirelessly or via a wired connection, the internal notification system indicating when a user has depressed the button. A kit is also disclosed, the kit incorporating a selected group of the elements listed above.

### BACKGROUND OF INVENTION

The present invention relates to a method and system that can be used in conjunction with an ordering system, and particularly to a method and system that facilitates taking orders from hard-of-hearing and deaf individuals. More particularly, the present invention relates to a method and system that can be connected to a service venue (for example a drive-thru window and/or restaurant) for providing better access and service to hard-of-hearing and deaf individuals.

### SUMMARY OF INVENTION

The present disclosure relates to one or more of the following features, elements or combinations thereof. A method and system for taking orders from or providing service to a person are disclosed. The system and method may include a notification system and station that notifies a service associate of the need for assistance, and an ordering station wherein service is provided to the user in need. A button may be used as a trigger for a user to indicate he needs assistance. An internal notification system may be connected either wirelessly or via a wired connection, the internal notification system indicating when a user has depressed the button.

A kit is also disclosed. The kit may contain a number of the elements of the system, such that a service venue can retrofit its ordering system to accommodate individuals needing assistance, i.e. hard-of-hearing and deaf individuals.

Additional features of the disclosure will become apparent to those skilled in the art upon consideration of the following detailed description of preferred embodiments exemplifying the best mode of carrying out the invention as presently perceived.

### BRIEF DESCRIPTION OF THE DRAWINGS

The detailed description particularly refers to the accompanying figures in which:

FIG. 1 is a perspective view of a service venue showing a vehicle passing through a drive-thru;

FIG. 2 is an exploded view of a notifier configured to be placed at a point in the drive-thru where it is desirable to notify the service associate of a user needing assistance;

FIGS. 3A and 3B illustrate different embodiments of the instructions and the proximity of such instructions to the notifier;

FIG. 4 shows a user in the process of depressing a button on the notifier;

FIG. 5 shows a cut-away view of a service venue having an internal notification system installed, the notification system being in communication with the notifier being depressed by an operator;

FIG. 6 shows a perspective view of a menu pad that can be used to place an order;

FIG. 7 shows a perspective view of a menu/order form holder; and

FIG. 8 shows a clipboard that can be used by a customer placing an order.

### DETAILED DESCRIPTION OF THE DRAWINGS

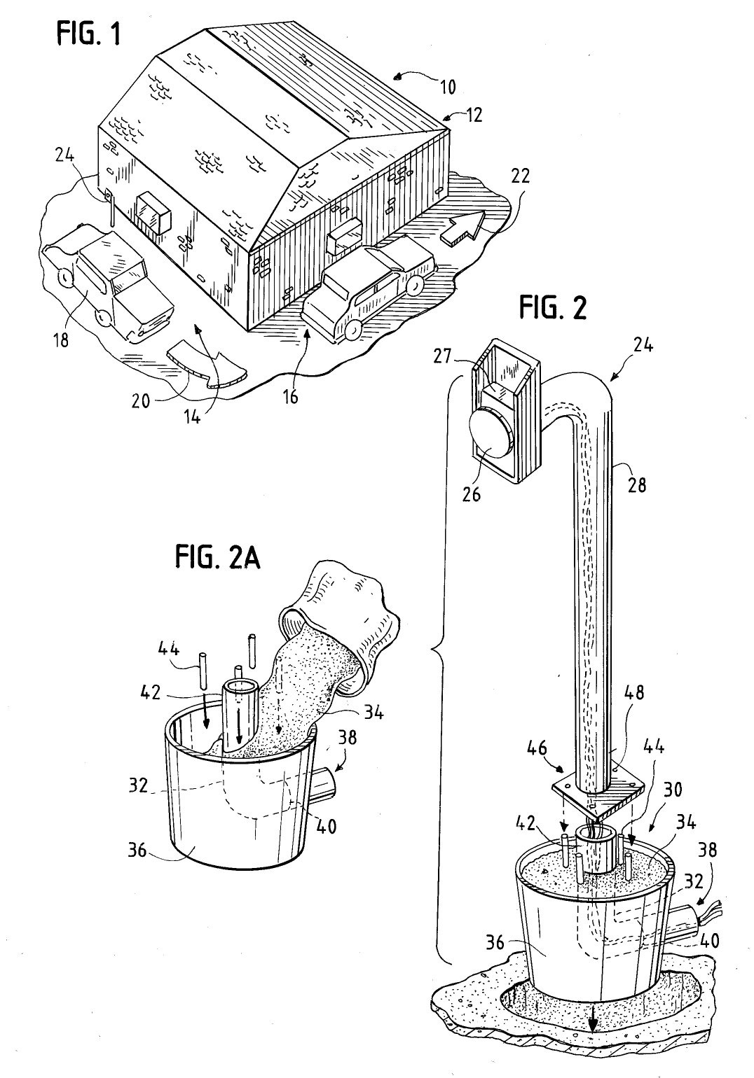

One embodiment of the present disclosure is shown in FIG. 1 in the form of a system 10 for taking customer orders. In the illustrative embodiment, the system 10 comprises a service venue 12, a notification station 14, and an ordering station 16. In the illustrated embodiment, a vehicle 18 proceeds in the direction shown by arrows 20, 22 around venue 12 and places an order at ordering station 16, such as what a drive-through restaurant may provide.

Notification station 14 may comprise a notifier 24, as can be seen in FIG. 2. In one embodiment, notifier 24 may include a button 26 that can be depressed in order to send a message to operators, such as restaurant employees, of venue 12. In the illustrated embodiment, notifier 24 further includes a post 28 that positions button 26 at approximately the window level of a passing vehicle. The illustrated embodiment further shows an anchor 30 that fixes post 28 such that it protrudes above the ground level in a permanent manner.

Anchor 30 has a conduit 32 that is positioned prior to a weighted material 34, such as cement, being poured into container 36. Once the weighted material 34 is placed, conduit 32 can be used to route communication and power wires that may be needed by button 26.

In the presently disclosed embodiment, container 36 is a plastic bucket. In one embodiment, container 36 is filled with weighted material such as cement 34 while elbow-shaped conduit 32 is held in place, with the lower end 38 of conduit 32 protruding through an aperture 40 formed in container 36. Upper end 42 of conduit 32 extends upwardly out of weighted material 34 and can be positioned so that it would extend into the interior of post 28.

Bolts 44 can also be fixed in the weighted material (such as cement) 34, such that bolts 44 extend upwardly from the weighted material in a parallel fashion so as to engage with a mating end 46 of post 28. In the disclosed embodiment, four apertures 48 receive four bolts 44 and anchor 30 is thereby fixedly connected to post 28.

As can be seen in FIG. 2, anchor 30 can be placed into a hole 50 that is dug into the ground or other material. Lower end 38 of conduit 32 can be positioned to point power and communication wiring toward the service venue 12.

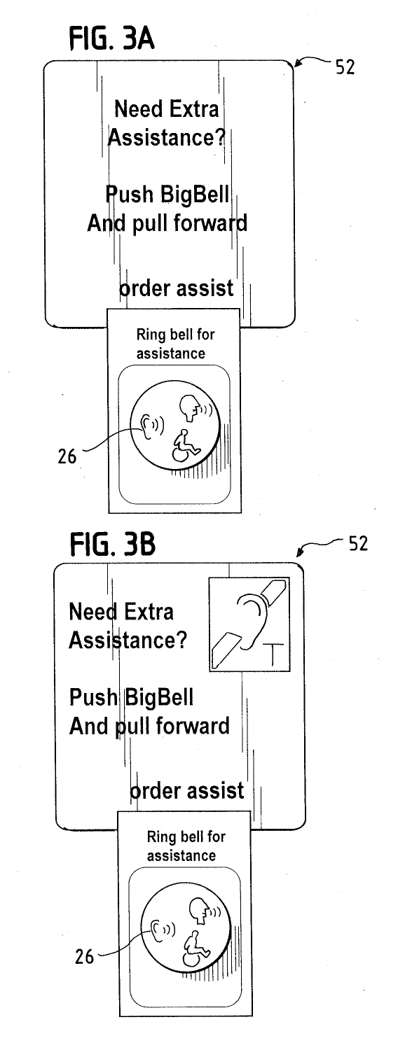

FIGS. 3A and 3B illustrate one embodiment of what button 26 and its adjoining components may look like. In the illustrated embodiment, an instruction panel 52 is disclosed, the instruction panel providing instructions for use of button 26 and how to proceed through to ordering station 16. Such instructions may be varied depending on the service venue 12. In one embodiment, button 26 has a large pressing surface and requires minimal pressure to activate consistent with the Americans with Disabilities Act of 1990 (ADA) and Americans with Disabilities Act Accessibility Guidelines (ADAAG) requirements. In the illustrated embodiment, button 26 is round and approximately three inches (7.5 cm) in diameter.

Button 26 may be joined by a weather-resistant housing 27 (visible in FIG. 2) for protecting certain components associated with the notifier 24. Housing 27 may be assembled using weather proof seals as deemed necessary. In one embodiment, the housing does not have holes, thereby further safeguarding against the elements and weather. The housing may also have punch-out holes in the back that allow for compromise of the housing when necessary to the installation, but maintain the integrity of the housing for other applications. Housing 27 may include a battery pack if it is not hard-wired to electricity. In the ADA-compliant embodiment, button 26 is ideally capable of being activated by merely the pressing of a user's finger against the button. A person with limited manual dexterity should be able to use other elements, such as a fist or elbow or even his or her head, for example. Button 26 can also be activated by a cane or other piece of assistive technology.

Referring to FIGS. 3A-3B, system 10 may also include an instruction panel (or signage) 52 that indicates to customers the existence of assistance for deaf or hard of hearing customers. The instruction panel 52 of the preferred embodiment has several components. First, it may include international symbols for disabled persons, deaf persons, hard of hearing, and/or individuals with speech disabilities. Secondly, it may provide instructions to ring the bell for assistance.

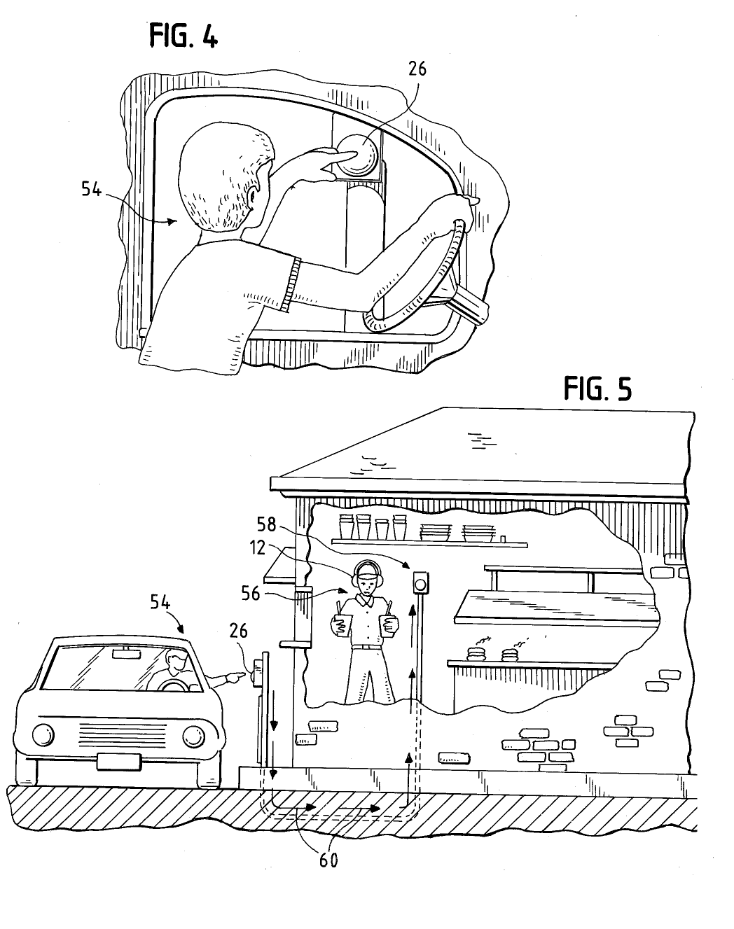

FIG. 4 illustrates a user 54 pushing button 26 so as to indicate that the user will need extra assistance. It is contemplated that a plurality of buttons may be included on post 28, such that a multiple of purposes may be achieved. For example, button 26 could indicate to the service venue 12 that the user needs assistance and will be driving up toward the ordering station 16. Another button (not shown) may be provided with instructions that it is for customary ordering, and notifies an attendant that the user wishes to place a verbal order at the notification station 14. A camera may also be included.

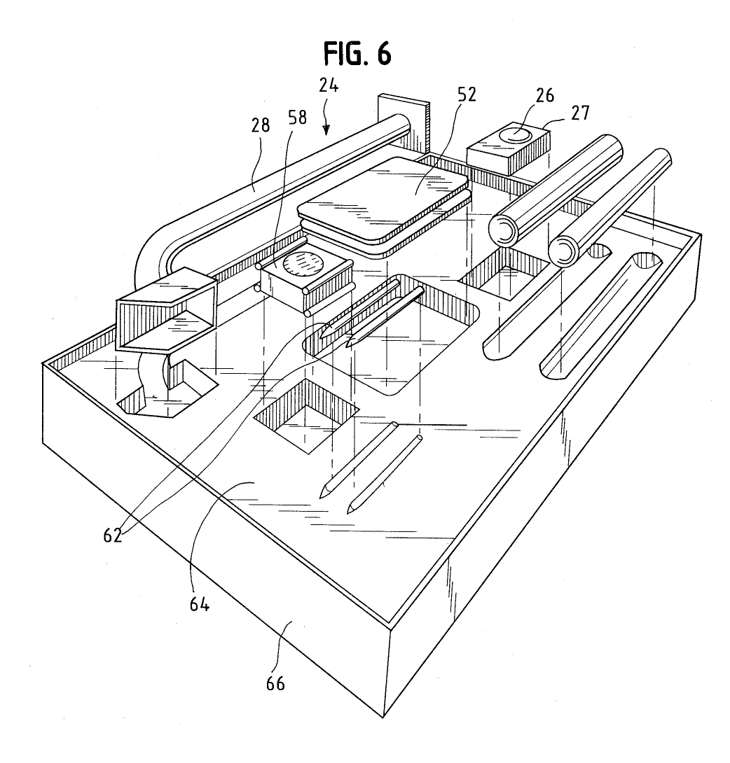

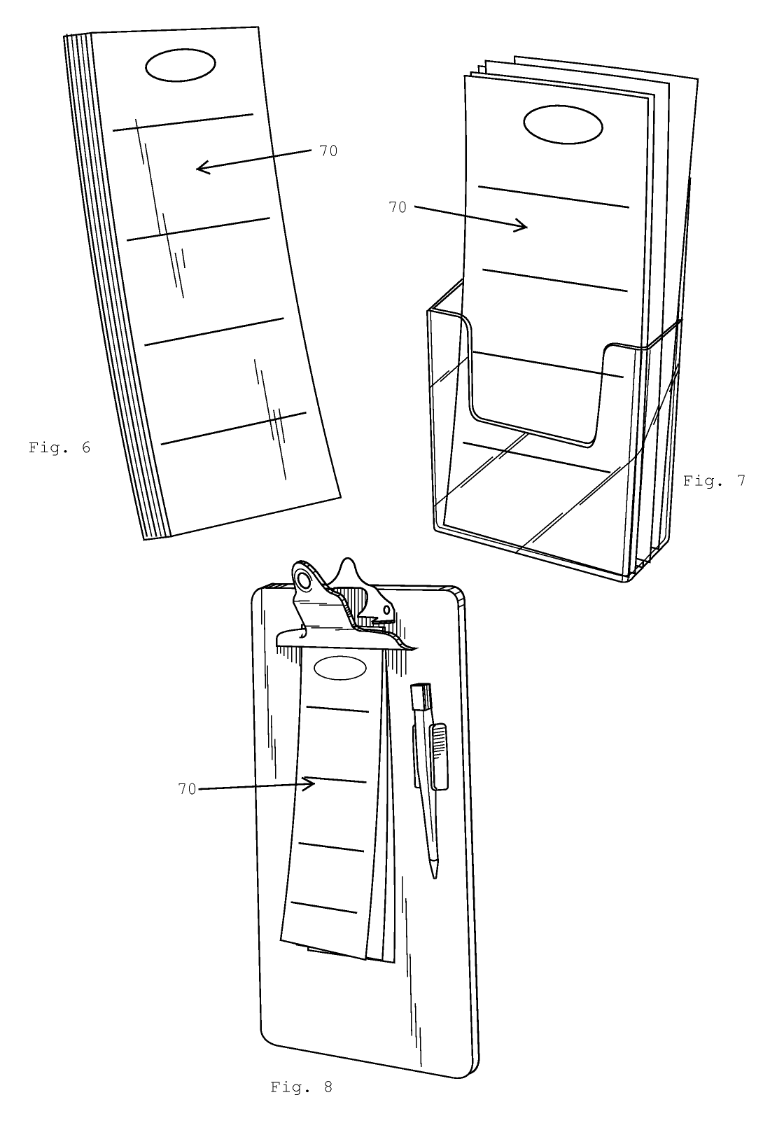

Still other embodiments are within the scope of the disclosure. For example, a menu/ordering sheet 70, as shown in FIGS. 6-8, could be utilized by the service venue 12. Such an ordering sheet could be picked up in advance or could be offered at the service venue near the notification station 14. Other embodiments of the ordering sheet 70 include a pad of paper and a pen for placing orders, or even a picture menu. Service venue 12 could provide a scanning device such as a camera, a scanner, a digital reader, or any other type of device that can take input from an ordering sheet 70 and digitize it for transmission to the service venue 12. Illustratively, the scanning device reads orders from the ordering sheet 70. A user 54 could insert such an order sheet 70 at a pre-determined scanner location, or could simply present the ordering sheet 70 to a service associate 56 (shown in FIG. 5), who in turn could either read or scan in the order sheet 70. In yet another embodiment, pneumatic tubes could transport the order from the user 54 to the service associate 56.

FIG. 5 illustrates a cut-away view of a service venue 12, showing an internal notification system 58. In the illustrated embodiment, service venue 12 is provided with an internal notification system 58 that is in communication with button 26. The communication is shown as a wired communication system that passes signals 60; however, it should be understood that wireless communication is within the scope of the disclosure.

In the illustrated embodiment, internal notification system 58 provides a visual and/or an audible signal that a person needing assistance has pushed button 26. An LED may be provided. The LED may flash or otherwise indicate that a user 54 is present and has depressed button 26. Notification system 58 may also be configured to coordinate with a menu-ordering system, such that the user 54 is placed in the ordering line even if the service associate 56 has not yet received an order. Notification system 58 may further indicate visually or through any other messaging means that the user 54 will be needing assistance. In the embodiment described above where orders can be taken via a scanner, the user's order can be queued and entered in the system via the scanner. In another embodiment, the user may use a pad of paper, touch pad, or other type of ordering system in order to queue his order.

It is contemplated that a headset 62, configured for use by service associates 56 may also be used and may be in communication with notification system 58. Headset 62 may be, for example, a 3M model C1060 4-headset system as is sold by 3M and its various distributors.

Notification system 58 may have an internal receiver configured to communicate with headset 62 and/or with notifier 24—either wirelessly or wired. A service associate 56 may be further trained to work with hearing impaired individuals or other individuals/users needing assistance. Instructions for such training may be included with a kit, as would be selected items described herein.

In yet another embodiment, a hearing loop system can be installed. Such a system could be advertised at the instruction panel 52, discussed above. According to this embodiment, a hearing loop system includes an inductive coil capable of transmitting sounds to a hearing aid. For example, the hearing aid may have a telecoil (known as a “T-coil”) apparatus which can be tuned to a particular frequency. A hearing aid user is able to switch the hearing aid to the T-coil position and receive broadcasts from the hearing loop system using the user's existing hearing aid. In another embodiment, the car may be outfitted with a T-coil system. Either way, with the aid of a T-coil system, a hard-of-hearing user may utilize the service venue 12 just as anyone else. It may be necessary in some installations to push the switch to notify an employee to turn on the T-coil system. Button 26 could also initiate this system and instruction panel 52 may indicate the presence (and instructions for) such a system. The T-coil system could be one of several different types and manufacturers in the field. An example of a T-coil system is the Ampetronic Induction Loop Driver ILD 60, manufactured by Ametronic Ltd. in London, England.

The system may be packed in the form of a kit, which can include some, many, or all of the components described herein. The kit may also include a plurality of some components. The kits may be provided in different versions depending on the needs of the service venue, or alternately a basic kit (shown in FIG. 6 and described below) is provided with the components most commonly used at a drive-through facility and an order form is provided for the facility to order needed additional components and materials. The kit may be provided in a box or other container or may be provided in several containers. Finally, the kit can include instructions for installation and use of the components and preferably has information on the issues faced by the hearing impaired and ways to facilitate communications between attendants and hearing impaired customers.

In one example having certain components shown in FIG. 6, the kit includes notifier 24 (which includes post 28 and housing 27/button 26), a notification system 58, customized instruction panels 52, customized pens or pencils 62, counter organizers (not shown), customized order forms (not shown), and instructions and training materials for staff and employees. The customized order forms could also be configured to provide scannable portions that allow for digitized reading of the order being placed. The kit may be packaged in foam 64 and/or a box 66.

In one method of providing service to a hearing impair individual, a service provider is notified of the presence of a hard-of-hearing individual prior to the individual being visible to the service provider. This is accomplished via the notification system disclosed above, or via an order that can be placed using a specialized internet page for hearing impaired or deaf individuals. A place-holder may be created for the individual's order. A place-holder would allow the individual's order to be processed in the same timeframe as it would have had the individual placed the order via traditional means.

The method further includes the step of receiving an order from the individual. Once the order is received, it can be placed in the place-holder position referenced above and fulfilled in the order in which it is placed. The order may be received via a scanner that is positioned in the drive-thru service area or via other means, such as the internet page referenced above. The place-holder position may be coordinated with the order as it was previously entered online. For example, a user input device may be provided (such as a numeric keypad or the like) that permits a user to confirm the order placed via the internet, thereby linking the order previously placed and the individual's location in line.

The present invention provides a system and method for making a service venue (i.e. a drive-through facility) accessible to the hard of hearing. The present invention also provides a kit for retrofitting/converting a service venue to one more easily used by a person with a hearing impairment. The details of the methods are apparent from a review of the foregoing description.

While the disclosure is susceptible to various modifications and alternative forms, specific exemplary embodiments thereof have been shown by way of example in the drawings and have herein been described in detail. It should be understood, however, that there is no intent to limit the disclosure to the particular forms disclosed, but on the contrary, the intention is to cover all modifications, equivalents, and alternatives falling within the spirit and scope of the disclosure as defined by the appended claims.

A plurality of advantages arises from the various features of the present disclosure. It will be noted that alternative embodiments of various components of the disclosure may not include all of the features described yet still benefit from at least some of the advantages of such features. Those of ordinary skill in the art may readily devise their own implementations of a method and system that incorporate one or more of the features of the present disclosure and fall within the spirit and scope of the disclosure.

What is claimed is:

1. A kit for providing service to hard-of-hearing individuals, the kit comprising:
a notifier for sending a message to a service venue;
a notification system for receiving a message and indicating the need for service;
a plurality of customized order forms for providing a hard-of-hearing individual a method in which to communicate; and
a customized instruction panel for providing instructions to hard-of-hearing individuals.

2. The kit of claim 1, further comprising an order form having a scannable portion.

3. The kit of claim 1, wherein the customized order form is a pad of paper and a writing utensil.

4. The kit of claim 1, wherein the notification system is configured to be utilized with a headset.

5. The kit of claim 1, further comprising a hearing loop system including an inductive coil capable of transmitting sounds to a hearing aid.

6. The kit of claim 5, wherein the hard-of-hearing individual can adjust a hearing aid to receive signals from the inductive coil.

7. The kit of claim 1, further comprising a pneumatic tube delivery system for delivering the customized order form to a service provider.

8. A kit for providing service to hard-of-hearing individuals, the kit comprising:
a notifier for sending a message to a service venue;
a notification system for receiving a message and indicating the need for service;
a plurality of customized order forms for providing a hard-of-hearing individual a method in which to communicate; and
an order form having a scannable portion.

9. The kit of claim 8, further comprising a scanner.

10. The kit of claim 9, wherein the scanner is located at a notification station.

11. The kit of claim 9, wherein the scanner is located at a drive-through service area.

12. The kit of claim 8, wherein the notification system is configured to be utilized with a headset.

13. The kit of claim 8, further comprising a hearing loop system including an inductive coil capable of transmitting sounds to a hearing aid.

14. The kit of claim 13, wherein the hard-of-hearing individual can adjust a hearing aid to receive signals from the inductive coil.

15. The kit of claim 13, further comprising a user input device for confirming a previously placed order.

16. A method of providing service to hard-of-hearing individuals, the method comprising the steps of:
notifying a service provider of the presence of a hard-of-hearing individual prior to the individual being visible to the service provider;
creating a place-holder for the individual's order;
receiving an order from the individual;
placing the order in the place-holder; and
fulfilling the individual's order.

17. The method of claim 16, further comprising the step of scanning in the individual's order.

18. The method of claim 16, further comprising the step of providing a customized order form to the individual.

19. The method of claim 16, further comprising the step of providing a hearing loop system for the individual.

20. The method of claim 16, further comprising the step of providing an online ordering method for the individual.
